(19) United States
(12) Patent Application Publication
(10) Pub. No.: US 2010/0217907 A1
(43) Pub. Date: Aug. 26, 2010

(54) KVM switch expansion device

(75) Inventor: Wen-Cheng Lin, Danshuei Township (TW)

Correspondence Address: Jackson Intellectual Property Group PLLC, 106 Starvale Lane, Shipman, VA, 22971, US

(73) Assignee: TANGTOP TECHNOLOGY CO., LTD.

(21) Appl. No.: 11/826,822

(22) Filed: Jul. 18, 2007

(51) Int. Cl. G06F 13/00

(52) U.S. Cl. 710/300

(57) ABSTRACT

A KVM switch expansion device includes a box disposed with multiple I/O ports thereon and containing a control component connected to those I/O ports; one or a multiple space is disposed to the box for accommodating expansion module at where other than those I/O ports are provided or the expansion module is separately provided in the form of another box to directly create telecommunication connection with the control component by means of a connection interface for the existing KVM switch to provide new user interface with an expansion module.

### BACKGROUND OF THE INVENTION

(a) Field of the Invention

The present invention is related to a KVM expansion device, and more particularly to one that allows a user to add expansion module as desire to increase new user interface.

(b) Description of the Prior Art

When a computer fails to satisfy user requirements for cause of work or updating facilities, buy a new one or continue using an old one might come up a very good option; however, not in the past on considering limited space and budget. Today, in either option, it takes only to purchase an additional KVM switch for connection in series to allow multiple computer hosts share a keyboard, mouse, video monitor, and even speaker, or microphone, and various types of externally connected peripheral electronic equipment. Accordingly, a user not only enjoys broader workspace for improved work efficiency but also saves costs of purchasing additional keyboard, mouse, and monitor.

KVM (keyboard, video monitor, and mouse) switch is a hardware switch that allows a user to control multiple computers from a single keyboard, video monitor and mouse for switching among video monitors to simplify operation equipment in multiple-computer environment while synchronously executing management over different computers or servers through fast switch without interrupting then existing task. KVM switch presents a very convenient design for a user who is very serious about operating efficacy. Therefore, the KVM switch becomes more popular among users.

However, a user interface of the KVM switch of the prior art is fixed and the user has to purchase a new KVM switch to cope with changes in user requirements; furthermore, the KVM switch interface prevents from replacement as desired.

### SUMMARY OF THE INVENTION

The primary purpose of the present invention is to provide a KVM switch expansion device that allows a user to increase expansion module for adding new user interface.

To achieve the purpose, the present invention is essentially comprised of a box with multiple I/O ports are disposed thereon and a control component connected to those I/O ports are contained therein. One or a plurality of opening and an accommodation space connected through the opening is disposed to the box at where other than those I/Os ports are located. The accommodation space receives an expansion module, which is provided with one or a plurality of expansion interface telecommunication connected to the control component by means of a connection interface.

Alternatively, the expansion module is provided in another box to achieve telecommunication connection directly using the connection interface and the KVM switch control component so to increase new user interface through the expansion module.

### BRIEF DESCRIPTION OF THE DRAWINGS

FIG. 1 is a perspective view showing a KVM switch and an expansion device of a first preferred embodiment of the present invention.

FIGS. 2(A) and 2(B) are exploded views respectively showing local parts of the first preferred embodiment.

FIG. 3 is an exploded view of a second preferred embodiment of the present invention.

FIG. 4 is an exploded view of a third preferred embodiment of the present invention.

FIG. 5 is an exploded view of a fourth preferred embodiment of the present invention.

### DETAILED DESCRIPTION OF THE PREFERRED EMBODIMENTS

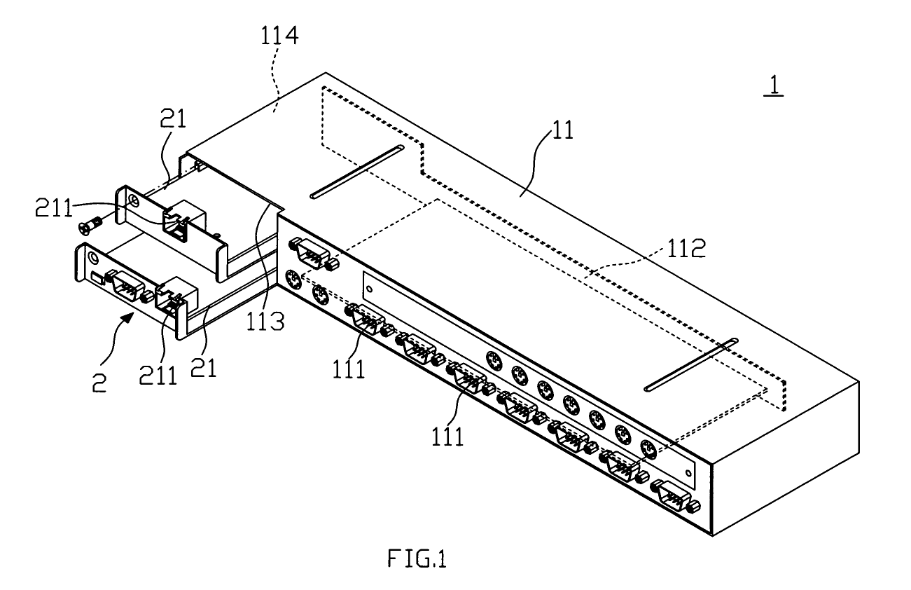

Referring to FIG. 1, a KVM switch 1 of the present invention is essentially comprised of a box 11, on one side of the box 11 is disposed with multiple I/O ports 111, a control component 112 related to a circuit board and connected to those I/O ports is provided in the box 11.

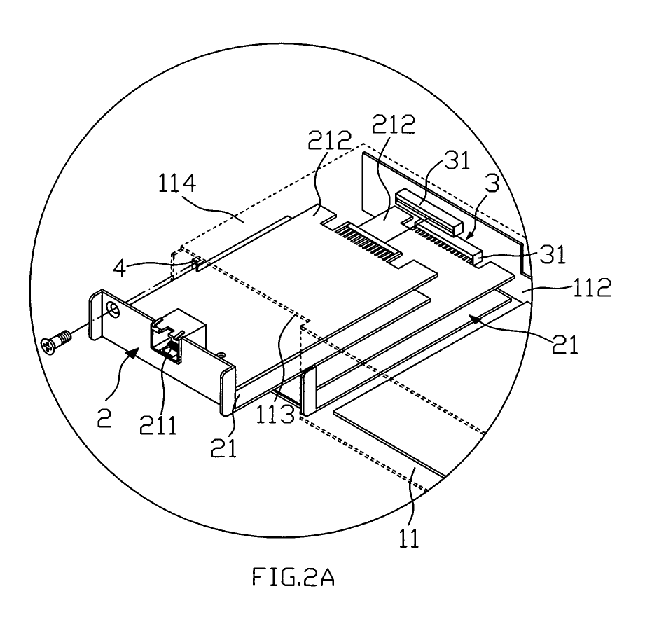

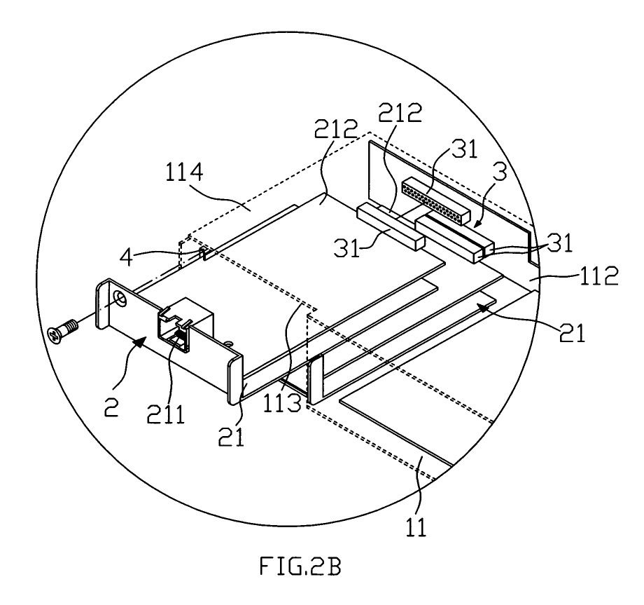

One or a plurality of opening 113 and an accommodation space 114 are provided to the box 11 at where other than those I/O ports are located. Also as illustrated in FIG. 2(A), the accommodation space 114 receives an expansion module 2 and one or a plurality of expansion interface 21 is disposed to the expansion module 2. As illustrated, the expansion interface 21 is disposed with an expansion I/O port 211 and an expansion control component 212 connected to the expansion I/O port 211. The expansion control component 212 is related to a circuit board, and a connection interface 3 is disposed between the expansion interface 21 and the control component.

Upon assembling the KVM switch, the expansion interface 21 is inserted into the accommodation space through the opening 113 of the box 11. In the preferred embodiment as illustrated, a rail 4 is provided at where between the accommodation space 114 and the expansion interface 21 to facilitate assembling and provide locating results. As the expansion interface 21 slides along the rail 4 into the accommodation space 114, a telecommunication connection is created between the expansion interface 21 and the control component 112, wherein the connection interface 3 is related to a connector 31 provided on the control component 112 and the expansion control component 212 on the expansion interface 21 is plugged into the connector 31. Alternatively, the connection interface 3 is related to the connector 31 disposed on the control component 112 and the expansion control component 212 as illustrated in FIG. 2 (B) to achieve the same telecommunication connection between the expansion interface 21 and the control component 112.

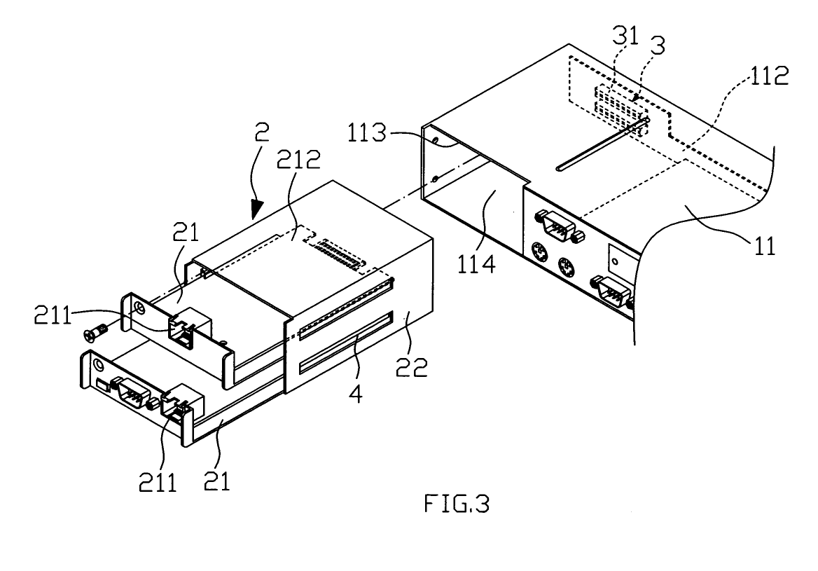

In a second preferred embodiment as illustrated in FIG. 3, the expansion module 2 further includes a fixed rack 22 and one or a plurality of expansion interface 21 provided in the fixed rack 22. The expansion interface 21 is provided with an expansion I/O port 211 and an expansion control component 212 connected to the expansion I/O port 211. Upon assembling, a rail 4 is provided at where between the fixed rack 22 and the expansion interface 21, and another rail 4 is disposed at where between the accommodation space 114 and the fixed rack 22 so that each expansion interface 21 slides and secured in the accommodation space 114 to achieve the same telecommunication connection between the expansion interface 21 and the control component 112 by means of the connection interface 3. As illustrated, the connection interface 3 is related to a connector 31 disposed on the control component 112 and the expansion control component 21 on the expansion interface 21 is plugged into the connector 31. The connection interface may be related to a connector disposed on the expansion control component to achieve the telecommunication connection between the expansion interface and the control component through plug connection.

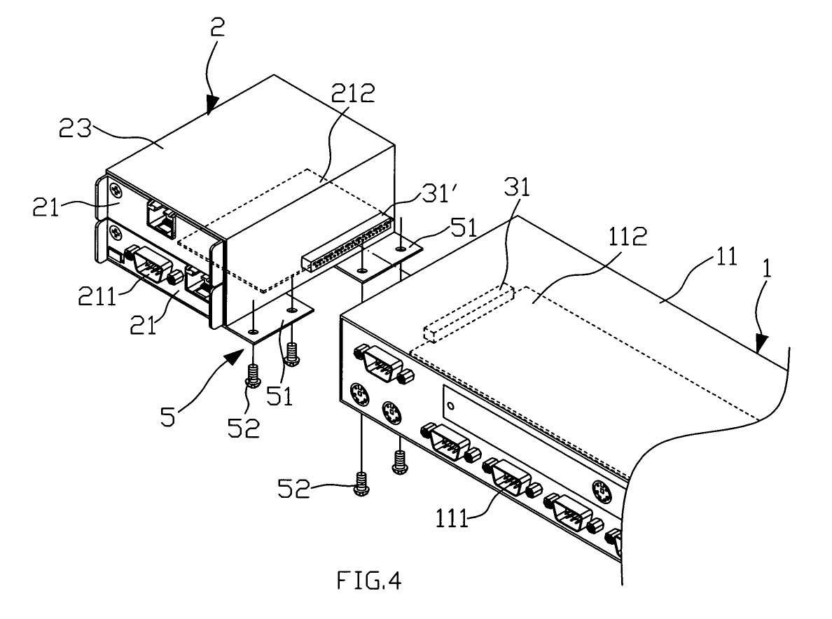

Now referring to a third preferred embodiment of the present invention as illustrated in FIG. 4, a box 11 is provided to the KVM switch 1. Multiple I/O ports 111 are provided on one side of the base 11 and the case 11 contains a control component 112, which is connected to those I/O ports 111. The control component 112 relates to a circuit board. An expansion module 2 is provided separately as a second box 23. The second box 23 contains one or a plurality of expansion interface 21, and the expansion interface is provided with an expansion I/O port 211 and an expansion control component 212, which is connected to the expansion I/O port 211. The expansion control component 212 is related to a circuit board.

Upon assembling the third preferred embodiment, a connection interface 3 is disposed between the box and the second box 23. As illustrated, the connection interface 3 is related to two connectors 31, 31′ respectively provided on the control component 112 and on the expansion control component 212. By plug connection of both connectors 31, 31′, a telecommunication connection is realized between the control component 112 and the expansion control component 212 thus to link the KVM switch and the expansion module 2 to each other. The connection interface is provided in a form of cabled connection including cable and plug, or in another form of wireless connection, e.g., 802.11a, 802.11b, 802.11g, 802.11n, infrared transmission or EM transmission.

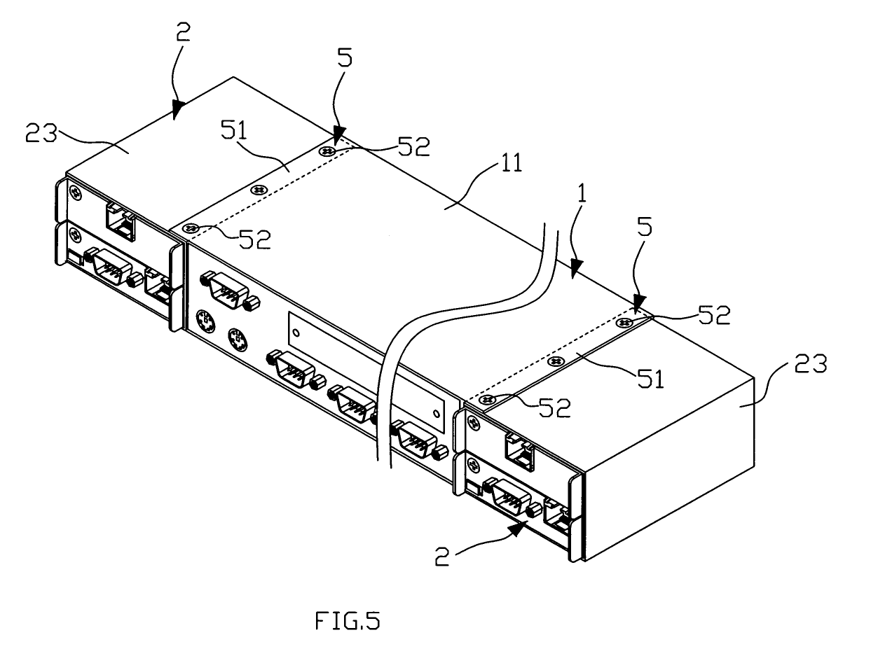

Furthermore, a fixation component 5 is further disposed at where between the box 11 and the second box 23. The fixation component 5 contains a locating member 51 extending from one side of the second box 23 towards the box 11, and a locating piece 52 (e.g., a screw). As illustrated in FIG. 5, the fixation component 5 contains a locating member 51 extending from one side of the case 11 towards to the second case 23, and a locating piece 52 (e.g., a screw). Locking in place between the box 11 and the second box 23 by means of the locating member 51 and each locating piece 52, the assembly strength between the KVM switch and the expansion module 2 is improved.

Alternatively, an expansion module 2 is mounted to one side of the KVM switch 1 as illustrated in FIG. 4 or two expansion modules 2 are respectively mounted to both sides of the KVM switch 1 as illustrated in FIG. 5. The expansion interface may be related to a CAT5 module or an IP module while the expansion I/O ports may be of RJ45, D89, or USB (e.g., mini-USB).

Compared to the prior art, the present invention provides the following advantages:

1. The user interface in a KVM switch of the prior art is related to a fixed interface while the present invention allows a user to provide additional expansion module as desired thus to switch among different user interfaces.

2. Upon replacing or assembling the expansion module in the present invention, it is not necessarily to remove the entire case; instead, simply directly insert the expansion module into the accommodation space or achieve the connection by forthwith using the connection interface in making assembly and removing easy and convenient.

The prevent invention provides an improved structure of a KVM switch expansion device, and the application for a utility patent is duly filed accordingly. However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

I claim:

1. A KVM switch expansion device comprising:
a box, multiple I/O ports being provided on the box, a control component being contained in the box and connected to those I/O ports, one or a plurality of opening and an accommodation space connecting through the opening being provided on the box at where other than those I/O ports are located; and
an expansion module, disposed in the accommodation space, containing one or a plurality of expansion interface, the interface being telecommunication connected to the control component by means of a connection interface.

2. The KVM switch expansion device as claimed in claim 1, wherein the expansion module is further comprised of a fixed rack, one or a plurality of expansion interface disposed in the fixed rack, an expansion I/O port is provided to the expansion interface, and an expansion control component connected to the expansion I/O port.

3. The KVM switch expansion device as claimed in claim 2, wherein a rail is disposed between the accommodation space and the expansion interface.

4. The KVM switch expansion device as claimed in claim 2, wherein a rail is disposed between the fixed frame and the expansion interface.

5. The KVM switch expansion device as claimed in claim 1, wherein the expansion interface is provided with an expansion I/O port and an expansion control component connected to the expansion I/O port.

6. The KVM switch expansion device as claimed in claim 5, wherein a rail is disposed between the accommodation space and the expansion interface.

7. The KVM switch expansion device as claimed in claim 2, wherein the control component and the expansion control component are respectively related to a circuit board, and the connection interface is disposed to a connector of the control component.

8. The KVM switch expansion device as claimed in claim 5, wherein the control component and the expansion control component are respectively related to a circuit board, and the connection interface is disposed to a connector of the control component.

9. The KVM switch expansion device as claimed in claim 2, wherein the control component and the expansion control component are respectively related to a circuit board, and the connection interface is disposed to a connector of the expansion control component.

10. The KVM switch expansion device as claimed in claim 5, wherein the control component and the expansion control component are respectively related to a circuit board, and the connection interface is disposed to a connector of the expansion control component.

11. A KVM switch expansion device comprising:
a box, multiple I/O ports being disposed thereon, and a control component connected to those I/O ports is contained therein;
one or a plurality of expansion module, containing a second box, and one or a plurality of expansion interface contained in the second box; and
a connection interface disposed between the box and the second box, and telecommunication connection being made between the control component and the expansion interface.

12. The KVM switch expansion device as claimed in claim 11, wherein the expansion interface is provided with an expansion I/O port and an expansion control component connected to the expansion I/O port.

13. The KVM switch expansion device as claimed in claim 12, wherein the control component and the expansion control component are respectively related to a circuit board, and the connection interface contains two connectors respectively disposed on the control component and the expansion control component.

14. The KVM switch expansion device as claimed in claim 11, wherein a fixation component is disposed at where between the box and the second box.

15. The KVM switch expansion device as claimed in claim 14, wherein the fixation component contains a locating member extending from one side of the box towards the second box.

16. The KVM switch expansion device as claimed in claim 14, wherein the fixation component contains a locating member extending from one side of the second box towards the box.

17. The KVM switch expansion device as claimed in claim 11, wherein the connection interface is related to a cabled connection form comprised of cable and terminal.

18. The KVM switch expansion device as claimed in claim 11, wherein the connection interface is related to a wireless connection form.

19. The KVM switch expansion device as claimed in claim 11, wherein the wireless connection is related to 802.11a, 802.11b, 802.11g, 802.11n, infrared transmission, or EM transmission.
